(19) United States
(12) Patent Application Publication
(10) Pub. No.: US 2012/0303789 A1
(43) Pub. Date: Nov. 29, 2012

(54) METHOD FOR MANAGING DATA IN A COMMUNICATION NETWORK

(76) Inventors: Bruno Bozionek, Borchen (DE); Karl Klaghofer, Muenchen (DE); Holger Prange, Muenchen (DE); Michael Tietsch, Kaufering (DE)

(21) Appl. No.: 13/574,902

(22) PCT Filed: Jan. 28, 2011
(86) PCT No.: PCT/EP2011/000407

§ 371 Date: Jul. 24, 2012

(30) Foreign Application Priority Data
Feb. 17, 2010 (DE) 10 2010 008 300.3

(51) Int. Cl. G06F 15/16

(52) U.S. Cl. 709/223

(57) ABSTRACT

Disclosed is a method for managing data in a communication network (10) comprising a connection (20), in particular a switch, and at least one local communication terminal connected to the connection device (20). The connection device (20) is connected to or equipped with a second management information base (MIB′), in which information related to the location of the communication terminal is written and is made available for use in a location-dependent service during a data management process, the location-dependent service being designed according to a discovery protocol. The data management process involves feeding the location-related information to the communication network (20) using a location information source (3) and transmitting the fed location-related information from the location information source (3) to the connection device. Across at least one section of the transmission path, the fed location-related information is transmitted according to the discovery protocol.

### CROSS-REFERENCE TO RELATED APPLICATIONS

This application is the United States National Phase of PCT International Application No. PCT/EP2011/000407, filed on Jan. 28, 2011, and claiming priority to German National Application No. 10 2010 008 300.3, filed Feb. 17, 2010.

### BACKGROUND OF THE INVENTION

1. Field of the Invention

Embodiments relate to a method for managing data in a communication network.

2. Background of the Related Art

The LLDP (Link Layer Discovery Protocol) is specified in standard IEEE 802.1AB issued by the IEEE (Institute of Electrical and Electronical Engineering).

The LLDP-MED (LLDP Media Endpoint Discovery) protocol is an expansion of the LLDP protocol that allows for recognition of the terminal location and therefore permits emergency calls, for example when using VoiP (Voice over IP).

In order to be able to offer such an emergency call service (ECS) or other location-dependent services in the affected communication network, it is necessary, as part of a data management process, for location information that concerns the individual terminal's location to be written to a management information base (MIB) as specified in standard IEEE 802.1AB and kept there until it is called up by the management information base when it is needed.

FIG. 1 shows a schematic system diagram of the principal components of an installed and configured first telecommunication network 1 to illustrate the aforementioned conventional data management process.

The first telecommunication network 1 uses the Internet Protocol (hereinafter designated as the “IP protocol”) and includes a first Layer-2 switch 2 that is connected to a first management information base MIB. Four first IP terminals in the form of two IP telephones T1, T2 and two IP computer stations R1, R2 are connected through respective LAN wired connections L1, L2, L3, L4 to the first Layer-2 switch 2. To enable location-dependent services, the LLDP-MED protocol is implemented in the first telecommunication network 1.

A management program running on a data management computer 4 is used to perform the aforementioned data management process. Under the control of the management program, first location information that concerns the location of the individual first IP terminals R1, R2, T1, T2 is written to the first management information base MIB by the data management computer 4 and stored there.

As part of installing the individual network components of the installed and configured first telecommunication network 1, each of the individual first IP terminals R1, R2, T1, T2, upon connection to the first Layer-2 switch 2, reports its capabilities to the switch, and in turn they receive the first location information assigned to each of them by the first Layer-2 switch 2.

The above-described known solution for the data management process is considered disadvantageous, based on its required use of a relatively complex and costly data management program.

### BRIEF SUMMARY OF THE INVENTION

Embodiments are used for managing data in a communication network. Said network includes a connection device, in particular a switch, and at least one non-central communication terminal connected to the connection device. The connection device is connected to or equipped with a management information base in which, as part of a data management process, location information that concerns the location of the communication terminal is written into and kept there for use by (or for) a location-dependent service. In this configuration, the location-dependent service uses the Discovery protocol. The data management process involves feeding the location information into the communication network from a location information source. The data management process further involves transmitting the location information fed into the communication network by the location information source from the location information source to the connection device. This entered location information is transmitted via at least one partial segment of the transmission path according to the Discovery protocol. Discovery protocols are known in the field in various forms and are supported by many network infrastructure devices that are required to operate a network (such as switches and routers), used in a particular configuration, for example, to send information to its network interfaces using the Discovery protocol. In this text, a “location information source” is understood to mean any device that is capable of feeding location information into the communication network.

In a configuration according to the invented method, the Discovery protocol is based on standard IEEE 802.1AB or is derived from standard IEEE 802.1AB.

According to one embodiment of the invented method, the location-dependent service is configured according to the LLDP-MED protocol or its derivatives.

According to one example of the invented method, a measurement device that is installed for routine testing to be performed after the installation of the communication terminal, in particular to test the function and/or service quality of the connection between an IP-connection assigned to the communication terminal and the connection device, is used as the location information source.

This has the advantage that implementing the data management process requires no additional technical equipment expense and only a small software expenditure to appropriately configure the measurement equipment. In addition, the additional operating expense can be kept low through the combined use of connection testing and data management.

### BRIEF DESCRIPTION OF THE FIGURES

FIG. 1 shows a schematic system diagram of the principal components of a first telecommunication network to illustrate the implementation of a conventional data management process; and

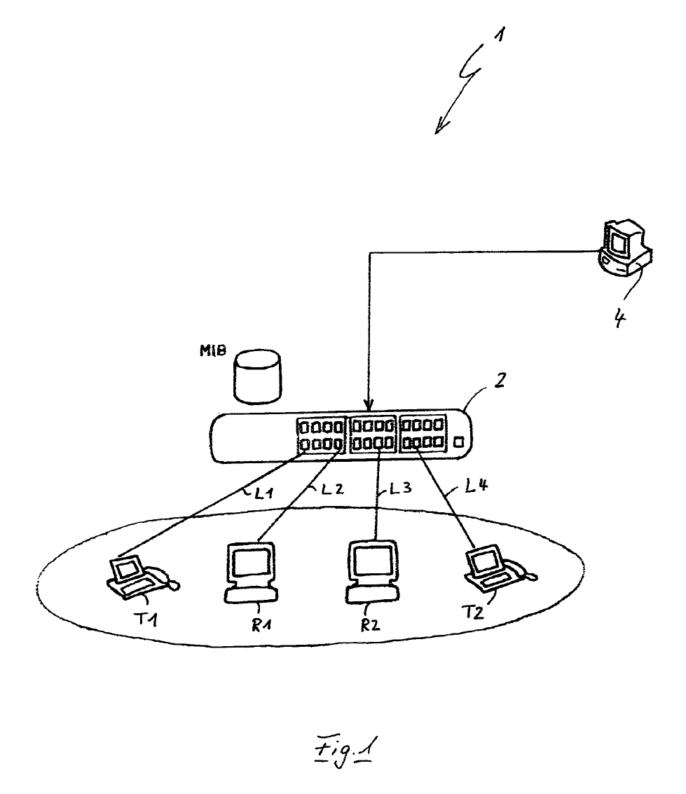

FIG. 2 shows a schematic system diagram of the principal components of a second telecommunication network in an initial state to illustrate the implementation of the invented method.

### DETAILED DESCRIPTION OF THE INVENTION

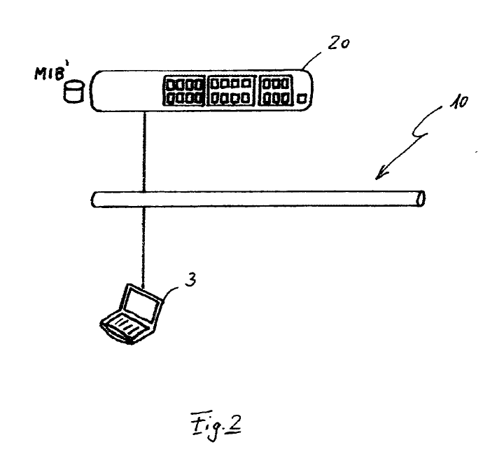

One example of the invention is described below in more detail and with reference to FIG. 2, showing a second telecommunication network 10 in an initial state, i.e., before the connection of multiple (not shown) second IP terminals to a second Layer-2 switch 20.

The second telecommunication network 10, consisting of a wired network, for example, also uses the Internet Protocol and includes a second management information base MIB′ connected to the second Layer-2 switch 2. The individual second IP terminals to be connected to the second Layer-2 switch 20 are to be placed at various locations within a building complex.

In the second telecommunication network 10, at least one location-dependent service configured according to the LLDP-MED protocol, such as an emergency call service (ECS) is available.

As part of the data management process, it is also necessary to have second location information, which clearly identifies the location of the individual second IP terminals within the building complex, written to the LLDP-MED-compliant second management information base MIB′ and kept available there until the second location information is called up by the second management information base MIB′ when needed.

In a specific stage during installation of the second telecommunication network 10, a test of the function and service quality of the connection between the second Layer-2 switch 20 and an IP connection in the form of a (not shown) connector jack assigned to the second IP terminal is run by means of a measurement device 3.

The measurement device 3 is also used to feed the location information for each second IP terminal into the second telecommunication network 10. This location information fed by the measurement device 3 is transmitted to the second Layer-2 switch 20 through the LLDP-MED protocol, expanded for this purpose.

In addition, for example, that transmitted location information is entered into the second management information base MIB′ and/or that transmitted location information is stored in the second management information base MIB′ according to the aforementioned expanded LLDP-MED protocol.

The location information for a second IP terminal located in a certain room in the building complex is specified, for example, in a format that includes the number of the building complex, the number of the floor on which the particular room is located, and the number of that room. Example: building No. 7205, 4th floor, room 443.

### DRAWING REFERENCES

1 first telecommunication network

2 first Layer-2 switch

3 location information source; measurement device

4 data management computer

5 data storage bank

10 second telecommunication network

20 second Layer-2 switch

L1, L2, L3, L4 wired LAN connections

MIB first management information base

MIB′ second management information base

R1, R2 computer work stations

T1, T2 IP telephones

1. A Method for managing data in a communication network including a connection device with at least one non-central communication terminal connected to the connection device, wherein the connection device is connected to or provided with a management information base unit, into which, as part of a data administration process, location information relevant to a location of the communication terminal is written and kept available for use in a location-dependent service, wherein the location-dependent service is configured according to a discovery protocol, and wherein the data administration process includes feeding the location information into the communication network from a location information source; and transmitting the fed location information from the location information source to the connection device, wherein the transmission is sent over at least one partial segment of a transmission path according to the discovery protocol comprising implementing a measurement device for testing at least one of function and service quality of a connection between an IP link assigned to the communication terminal and designating the measuring device as a location information source.

2. The method of claim 1, wherein the discovery protocol is based on standard IEEE 802.1AB.

3. The method of claim 2 wherein the location-dependent service is configured according to the LLDP-MED protocol.

4. (canceled)

5. The method of claim 1, wherein the connection device is a switch.

6. The method of claim 2, wherein the location-dependent service is configured according to a derivative of the LLPD-MED protocol.

7. The method of claim 1, comprising entering into the measurement device location information for a room in a building complex where the communication terminal is located when a measurement is made.

8. The method of claim 7, wherein the location information is specified in a format including a number of the building complex, a number of a floor on which the room is located, and a room number of the room.
